(19) United States
(12) Patent Application Publication
(10) Pub. No.: US 2005/0073080 A1
(43) Pub. Date: Apr. 7, 2005

(54) Hand trim tool

(76) Inventor: Mack Woodbury, Mt. Pleasant, MI (US)

Correspondence Address: John J. Swartz, 908 Court Street, Saginaw, MI, 48602, US

(21) Appl. No.: 10/606,397

(22) Filed: Jun. 27, 2003

(51) Int. Cl. B27B 5/00

(52) U.S. Cl. 269/41

(57) ABSTRACT

A hand tool for trimming a window frame including a corner clamp assembly for detachably clamping right angularly disposed coplanar trim members to right angularly related window frame members with the plane of the trim members being perpendicular to the plane of each frame member. The clamp assembly includes a frame mounting a pair of right angularly disposed clamp members each including an outer clamp face for clamping against an outer edge of one of the trim boards and a relatively moveable inner clamp face for clamping against one of the frame members.

### BACKGROUND OF THE INVENTION

1. Field of the Invention

This invention relates to a hand tool for trimming a frame for a building wall opening, such as a window or a door, and more particularly to a hand tool which detachably clamps trim pieces to a window or door casing while the trim is being attached to the casing.

2. Description of Prior Art and Objects

Window and door openings in a typical building construction are “roughed in” with a rectangular door or window casing including a bottom sill plate, an overlying header and repair of vertical side boards spanning the header and the sill plate. Typically, the opening has an irregular shape relative to the rectangular casing and thus, a gap exists between the casing and the wall. It is usual to mount trim members about the casing to cover the gap between the wall and the casing. The trim members typically comprise four trim members disposed at right angles to each other and at right angles to each of the window frame members and are nailed to the edges of the casing. It is typical that such trim members having abutting edges cut at complementally formed 45° angles.

Carpenters frequently work alone and it can be difficult for a carpenter to hold and correctly position two or more trim members on the window or door casing and concurrently nail the trim to the casing. Accordingly, it is an object of the present invention to provide a new and novel trim tool which holds individual trim members in right angular relation to allow a carpenter to use both hands to fasten the trim members to the casing.

To improve the aesthetics of window trim, it is important that the 45° abutting ends of the trim members be forced together in tight abutting relation to eliminate and/or minimize any gap that might otherwise exist therebetween if the trim members are not forced tightly together. Accordingly, it is another object of the present invention to provide a new and novel trim tool for urging abutting ends of trim members together to close the joint therebetween prior to being fastened to the casing.

Another object of the present invention is to provide a trim tool of the type described which will apply forces to the outer edges of the trim boards for urging the abutting margins of the trim boards under compressive pressure to close the joint between the abutting margins.

Sometimes, it is possible to preconstruct the trim frame in a shop and ship the assembled trim frame to the building site, however, this can cause substantial problems in shipping and storing a relatively fragile frame. Accordingly, it is yet another object of the present invention to provide a hand tool of the type described which will in situ hold the individual trim members to the window frame on site by reacting between the trim members and the casing for detachably holding the trim pieces to the casing.

It is a further object of the present invention to provide a trim tool of the type described which includes a pair of right angularly related clamp members.

It is still a further object of the present invention to provide a trim tool of the type described including a pair of right angularly clamp assemblies each including an outer clamp face for clamping against one of the trim members and a relatively moveable inner clamp face for clamping against the window casing.

In a conventional building construction, the edges of the planar window frame members are mounted flush with the drywall which typically covers buildings studs. The trim boards are mounted on the outer edges of the window frame members. It has been found according to the present invention that the clamp arm which clamps to the window casing must be longer than the clamp arm which clamps to the trim boards. Accordingly, it is still another object of the present invention to provide a trim tool of the type described having a frame mounting a pair of right angularly disposed clamp members of the type described each including an outer clamp face which projects away from the frame a predetermined distance and bears against the wall of the building and an inner clamp face which projects away from the frame a greater predetermined distance for clamping against one of the window frame members.

These and other objects of the present invention will become more readily apparent as the descriptions hereof proceeds:

### SUMMARY OF THE INVENTION

A framing hand tool for temporarily mounting individual frame pieces to an opening casing while the frame pieces are being fastened to the opening casing comprising a corner clamp assembly which reacts between the casing and at least a pair of right angularly related trim pieces for holding marginal portions of the trim pieces in abutting relation to form a joint.

### DESCRIPTION OF THE DRAWINGS

The invention may be more readily understood by referring to the accompanying drawings, in which:

FIG. 1 is a front elevational view illustrating trim frame pieces mounted on an opening casing, part of the trim frame being broken away to more clearly illustrate the window casing on which the trim frame is mounted;

FIG. 2 is an enlarged front elevational view of a hand tool constructed according to the present invention mounted on one of the corners of the frame illustrated in the chain line circle 2-2 of FIG. 1;

FIG. 3 is a greatly enlarged sectional taken along the section line 3-3 of FIG. 2, illustrating the framing tool mounting the trim frame on an opening frame which is disposed in a building wall;

FIG. 4 is a perspective view of the apparatus illustrated in FIGS. 2 and 3; and

FIG. 5 is a greatly enlarged sectional view of the portion illustrated in the chain line circle 5-5 of FIG. 3.

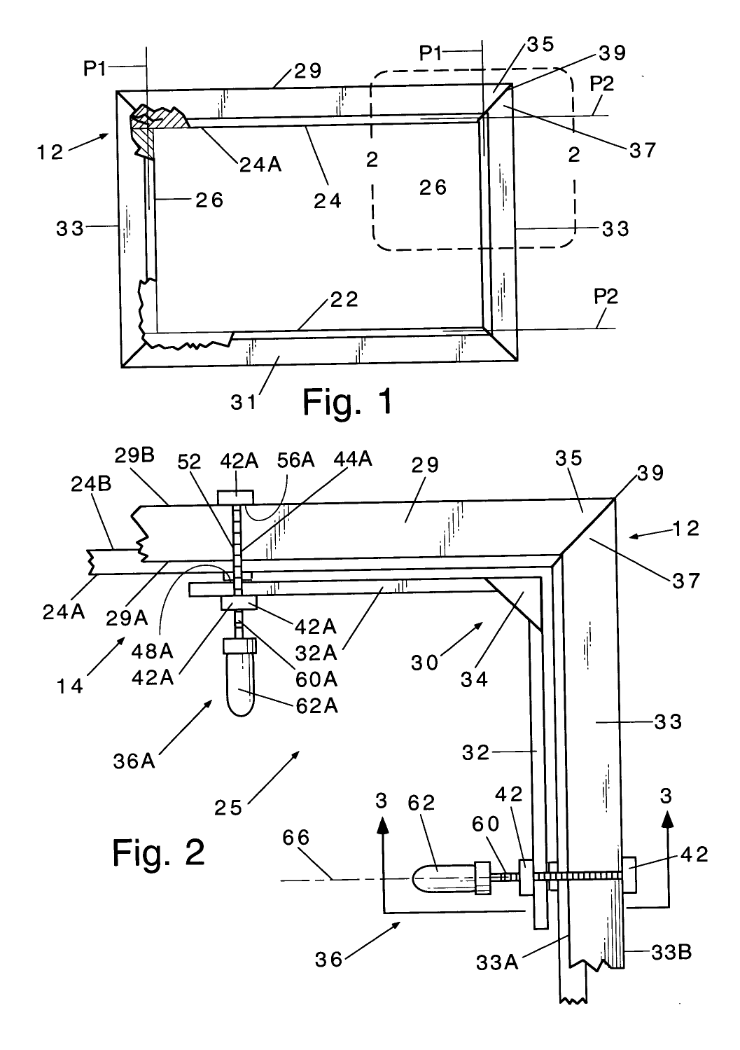

### DESCRIPTION OF PREFERRED EMBODIMENT

A trim tool, generally designated 10, constructed according to the present invention is particularly adapted for use in clamping a trim frame, generally designated 12, to an opening casing or frame 14 disposed in an opening 20 provided in a building wall, generally designated 16. The building wall 16 includes a plurality of upstanding studs 17 covered by panels 18 of drywall or the like. The opening or window casing 14 includes a bottom planar sill 22 and a parallel overlying header 24 spanned by vertical end frame boards or members 26 suitably nailed together. The casing 14 may be coupled to the wall 16 via nails 26. As illustrated, the end frame members lie in horizontally spaced apart, vertical planes P1 which are perpendicular to vertically spaced apart, horizontal planes P2 in which the sill 22 and header 24 lie.

The trim tool 10 includes a corner clamp assembly, generally designated 25, for clamping the trim frame 12 to the opening casing 14. The trim frame 12 includes top and bottom trim frame members 29 and 31, respectively, spanned by vertical end trim frame members 33 having marginal end portions 35 and 37 cut at complementally formed 45° angles and disposed in abutting relation to provide a joint 39. The top trim frame member 29 includes inner and outer edges 29A and 29B, respectively, and the side trim frame members 33 include inner and outer edges 33A and 33B, respectively. As illustrated in the drawing, the trim frame member 29, 31 and 33 all lie in a third plane P3 which is perpendicular to the planes P1 and P2 of the window casing members.

The corner clamp assembly 25 includes a corner clamp frame or mounting support, generally designated 30, including a pair of right angularly related support or arms 32 and 32A rigidly coupled together via a corner bracket 34. Mounted on the support arms 32 and 32A are clamping members 36 and 36A, respectively. Hereafter, the clamp 36 will be described in detail with the understanding that the clamp 36A includes similar parts followed by the reference character A.

The upstanding window frame members 26 each includes inner and outer planar faces 26A and 26B, respectively, spanned by forward and rear edges 26C and 26D, respectively. The header 24 includes similar outer parallel inner and outer faces 24A and 24B, respectively, spanned by forward and rear edges 24C and 24D, respectively.

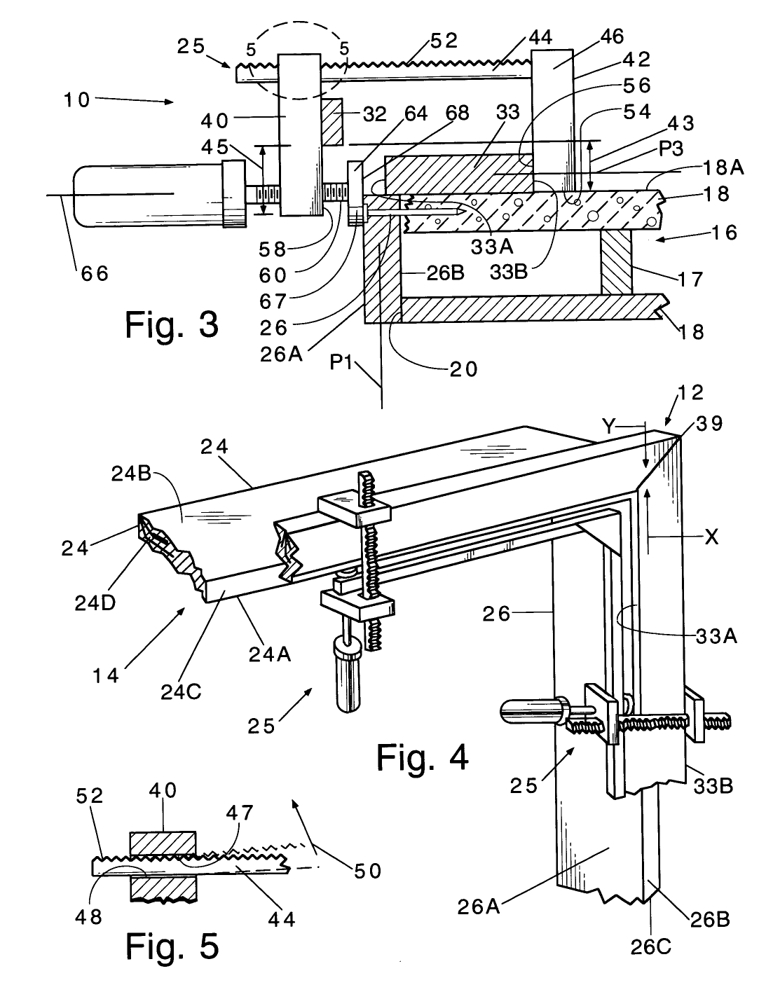

The clamp member 36 includes inner and outer clamp confronting arms 40 and 42, respectively, slidably coupled together via a rectangular rod 44 which is fixed to the forward end 46 of the outer clamp 42 and is linearly slidably moveable in an opening or slot 48 (FIG. 5) provided through inner clamp arm 40. The opening 48 is slightly larger than the rectangular rod 44 to allow slight swinging movement, in a forward direction, represented by the arrow 50, from the position illustrated in FIG. 5 to the position illustrated in chain lines in FIG. 5. When the clamp arms 40 and 42 are clamped in the positions illustrated in FIG. 3, the serrations or teeth 52 on the forward edge of the rod 44 engage the inside surface 47 of the opening 48 and hold the rod 44 in position to preclude relative separation of the clamp bars 40, 42.

The outer clamp arm 42 has a predetermined length and includes a rearward end portion 53 having an outer clamp face 56 for bearing against the outer edge 33B of the trim frame member 33. The end portion 53 includes a terminal end surface 54 which bears against the surface 18A of the drywall panel. The inner clamp arm 40 is longer than the outer clamp arm 42 and extends rearwardly away from the support frame 32 a greater distance 45 than the distance 43 which the clamp arm 42 extends rearwardly relative to support arm 32. The rear end of the inner clamp arm 40 includes a threaded opening 58 threadedly receiving a threaded rod 60 having a manually graspable handle 62 at one end and a pivot (not shown) rotatably mounting a clamp face 64 for bearing against the inner planar face 26A of the vertical casing member 26.

The threaded rod 60 is rotatable about its axis 66 which is aligned with the surface 18A and the terminal end 54 of the outer clamp arm 42 so that only the rearward half 67 of the inner clamp face 64 engages the window frame inner surface 26A. The forwardmost one-half portion 68 of the clamp face 64 does not engage the inner frame board surface 26A.

Method and Operation

It will be assumed that the building wall 16 is constructed as illustrated with an opening 20 having a window casing 14 mounted therein and nailed to adjacent studs 17 and/or the wall panels 18.

It will also be assumed that initially only the top trim board 29 and one vertical trim board 33 is disposed adjacent the upper right hand corner of the window frame 14 in the positions illustrated in FIGS. 3 and 4. The corner clamp hand tool 10 is mounted on the upper right hand corner of the opening frame 14.

Initially, the outer clamp arms 42 and 42A are preset relative to the inner clamp arms 40 and 40A by sliding the bars 44 and 44A in the openings 48 and 48A. This movement provides an initial rough adjustment of the clamp arms 40,40A, 42 and 42A so that the outer clamp faces 56 and 56A will bear against the outer edges 31B and 29B of the trim frame members 31 and 29, respectively. The tool 10 will be disposed such that the terminal end 54 of outer clamp arm 42 will bear against the wall forward surfaces 18A of the wall board 18.

The handles 32 and 32A are then turned to thread the rods 60 and 60A in the threaded openings 58 and 58A to outwardly move the inner clamp faces 64 and 64A, in the direction of the arrows 69, to force the inner clamp faces 64 and 64A against the forward edge portions of the inner, planar window frame faces 26 and 26A, respectively, of window frame planar panel members 33 and 29, respectively. The turning of the handles 62 and 62A will concurrently oppositely force the marginal abutting terminal trim frame ends 35 and 37 toward each other, in the direction of the arrows X and Y, to close the trim joint 39.

The clamp frames 36 and 36A thus react between the window frame 14 and the trim frame 12 to force the trim frame members 29 and 33 together to close the gap at the joint 39. With the trim frame members thus held, the carpenter is free to use both hands to nail the trim frame members 33 and 29 to the window frame members 26 and 24, respectively.

As the handle 62 continues to be turned to tightly clamp the inner clamp arms 40 and outer clamp arm 42 to the trim frame members 33, the outer clamp arm 42 and mounting rod 40 will swing forwardly slightly, in the direction of the arrow 50, to force the teeth or serrations 52 and 52A against the inside surfaces 47 to preclude separation of the inner and outer clamp arms 40 and 42 away from each other.

After the carpenter fastens the trim pieces 33 and 29 to the window frame members 26 and 24, respectively, the handles 62 and 62A are oppositely rotated to release the clamp arms 40, 42, 40A and 42A. The trim tool 10 is then moved to one of the other corners of the casing and clamped to another pair of trim frame members. The operation may be repeated until all of the trim frame members 29, 31 and 33 are fastened tightly together and secured to the window casing 14.

It is to be understood that the drawings and descriptive matter are in all cases to be interpreted as merely illustrative of the principles of the invention, rather than as limiting the same in any way, since it is contemplated that various changes may be made in various elements to achieve like results without departing from the spirit of the invention or the scope of the appended claims.

1. A framing hand tool for trimming an opening casing which includes at least two casing panels, each having front and rear edges and inner and outer faces spanning the front and rear side edges, coupled together at a 90° angle to form a casing joint, said framing hand tool comprising:
a corner clamp assembly including clamping means reacting between the casing and at least a pair of the right angularly related trim pieces, each having inner and outer edges, for urging marginal portions of said trim pieces into abutting relation with each other to form a trim joint in juxtaposition with the casing joint.

2. The framing hand tool set forth in claim 1 wherein said corner clamp assembly includes
a pair of right angularly related mounting bars;
a trim clamp mounted on each of said bars including
a first clamp arm including a first clamp face for bearing against said outer edge of one of said trim pieces; and
a second clamp arm including a second clamp face for bearing against the inner face of one of said panels.

3. The framing hand tool set forth in claim 2 wherein said corner clamp assembly includes means for adjusting the relative positions of said clamp arms toward and away from each other.

4. The framing hand tool set forth in claim 2 wherein said corner clamp assembly includes means, rotatable about an axis, for urging said second clamp face toward said first clamp face.

5. The framing hand tool set forth in claim 1 wherein said corner clamp assembly includes linearly moveable means adjustably mounting said first clamp arm for linear movement toward and away from said second clamp arm and rotatable means for adjustably mounting said second clamp face on said second clamp arm for movement toward and away from said first clamp face.

6. The framing hand tool set forth in claim 1 wherein said corner clamp assembly includes
a pair of right angularly related mounting support bars;
a trim clamp mounted on each of said support bars including
a pair of clamp arms; and
means for moving said pair of clamp arms toward and away from each other.

7. The framing hand tool set forth in claim 6 wherein said corner clamp assembly includes
means mounting one of said clamp arms to one of said frame bars;
linearly adjustable mount means mounting the other of said pair of clamp arms on said one clamp arm for linear movement toward and away from said one clamp arm;
a fixed clamp face mounted on said other clamp arm and a moveable clamp face adjustably mounted on said one clamp arms;
rotatably adjustable mount means mounting said moveable clamp face on said one clamp arm for movement toward and away from said fixed clamp face.

8. The trimming hand tool set forth in claim 1 wherein said corner clamp assembly includes
a pair of right angularly related support bars;
a trim clamp mounted on each of said support bars including
first and second spaced apart generally parallel mounting arms;
a first adjustable clamp face;
rotatable means adjustably mounting said first clamp face on said first arm for movement between a remote position and a clamping position clampingly engaging the inner face of one of said casing panels;
said second arm including a second clamp face for clamping to said outer edge of one of said trim pieces;
said first arm being fixed to said one of said mounting bars; and
means mounting said second arm for movement toward and away from said first arm to move said first clamp face into bearing engagement with said outer edge of said one trim pieces.

9. The trimming hand tool set forth in claim 1 wherein said clamping means clamps said trim members to said panels with the inner edge of each trim member being spaced outwardly of the inner face of the adjacent one of the casing panels.

10. The trimming hand tool set forth in claim 1 wherein said clamping means includes inner and outer clamping faces and means mounting said outer clamping face in clamping engagement with the outer edge of one of the trim members and said inner face in clamping engagement with the inner face of the adjacent one of the casing panels.

11. A clamping assembly for clamping two coplanar trim pieces, each having inner and outer edges, in right angular relation with margins thereof in abutment to form a first joint in juxtaposition with a second joint formed by abutting end portions of two right angularly related planar frame members having inner and outer planar faces, said clamping assembly comprising:
a mounting support;
a pair of right angularly related clamp members mounted on said mounting support;
each clamp member including
a pair of opposing inner and outer relatively moveable clamp faces; and
means for urging said clamp faces of each clamp member toward and away from each other including means for moving said outer clamp face into clamping engagement with one of said trim pieces and means for moving said inner clamp face into clamping engagement with the inner planar faces of one of the planar frame members.

12. The clamping assembly set forth in claim 11 wherein each clamping member includes a pair of spaced apart inner and outer clamp arms; said outer face being mounted on said outer arm and said inner face being movably mounted on said inner arm.

13. The clamping assembly set forth in claim 12 including rotatable means mounting said inner face on said inner arm and means adjustably mounting said outer arm for movement on said inner arm.

14. The clamping assembly set forth in claim 11 wherein said means for urging said clamp faces includes means for moving said outer clamp face into clamping engagement with said outer edge of said one trim piece, and means for moving said inner clamp face into clamping engagement with the inner planar face of the adjacent one of the planar frame members.

15. The clamping assembly set forth in claim 11 wherein said mounting support comprises a pair of right angularly related support bars; and means for mounting said support bars in a position inwardly of the planar frame members.

16. The clamping assembly set forth in claim 15 wherein each clamp member includes inner and outer clamp arms; said outer clamp arm mounting said outer clamp face and including a terminal end; and an inner threaded member, threadedly mounted on said inner arm for rotation about an axis, mounting said inner face for movement toward and away from said outer face.

17. The clamping assembly set forth in claim 16 wherein said axis and said terminal end lie in the same plane.

18. The clamping assembly set forth in claim 17 wherein said inner clamp arm includes a slot therethrough; and including a rod fixed to said outer arm and slidably adjustably received in said slot for adjustably mounting said outer arm on said inner arm.

19. The clamping assembly set forth in claim 18 including hand graspable handle means coupled to said threaded member for rotating said threaded member about said axis;
said slot being slightly larger than said rod to allow limited swinging movement of said rod relative to said inner clamp arm.

20. A trim tool for trimming an opening casing having
at least two right angularly disposed planar opening frame members,
lying in right angularly disposed first and second planes, and
having abutting end portions, forming a frame joint,
each frame member including inner and outer frame faces,
said trim tool comprising:
clamp assembly means for clamping a pair of right angularly related coplanar trim members to the two frame members with the plane of the coplanar trim members being perpendicular to the first and second planes of the frame members;
each of the trim members having inner and outer edges and an end abutting the end of the other trim member to form a trim joint adjacent the frame joint.

21. The trim tool set forth in claim 20 wherein said clamp assembly means comprises a mounting support including a pair of right angularly disposed support bars adapted to be mounted inwardly of the inner faces of the frame members; and
clamp apparatus mounted on each of said support bars including:
an inner clamp arm mounted on one of said support bars and an outer clamp arm mounted on said inner clamp arm and having an outer clamp face for clamping against the outer edge of one of said trim member; and
an inner clamp face provided on said inner clamp arm for clamping against the inner frame face of one of said frame members.

22. The trim tool set forth in claim 21 wherein said clamp apparatus includes means adjustably mounting said outer clamp arm on said inner clamp arm.

23. The trim tool set forth in claim 21 wherein said clamp apparatus includes means mounting said inner clamp face for movement on said inner arm toward and away form said outer clamp face.

24. The trim tool set forth in claim 23 wherein said means mounting said inner clamp face is rotatable.

25. The trim tool set forth in claim 20 wherein said clamp assembly means clamps said trim members to said frame members with said inner edge of each said trim member spaced outwardly of the inner face of the adjacent frame member.

26. The trim tool set forth in claim 20 wherein said clamp means includes an outer clamp face for clamping against said outer edge of one of said trim members and an inner clamp face for clamping against the inner frame face of one of the frame members; and means for moving said clamp faces toward and away from each other.

27. A trim tool for trimming an opening casing with a trim frame including at least two right angularly disposed trim boards each having inner and outer edges and a terminal end abutting the terminal end of the other trim board to form a trim joint, said opening casing being mounted in an opening provided in an upstanding wall having a vertical face, said opening casing having at least two right angularly disposed, planar frame members, having terminal abutting ends forming a frame joint, each planar frame members provided with inner and outer planar faces spanning front and rear edges, said front edges being disposed flush with the vertical face,
said trim tool comprising:
a corner clamp assembly for clamping the two right angularly disposed trim boards, to the front sides of the two frame boards with the inner edges disposed outwardly of the inner planar faces of the planar frame member and said trim joint disposed adjacent the frame joint.

28. The trim tool set forth in claim 27 wherein said corner assembly comprises clamp means reacting between the opening frame members and the trim boards for urging the terminal ends of said trim members into abutting relation.

29. The trim tool set forth in claim 28 wherein said clamp means includes inner and outer clamp faces, and means mounting said inner and outer clamp faces for movement between nonclamping positions and clamping positions in clamping engagement with at least one of said inner planar faces and at least one of said outer edges, respectively.

30. The trim tool set forth in claim 27 wherein said corner assembly includes a mounting support and a pair of clamp means mounted on said mounting support at right angles to each other for reacting between the inner planar faces of said frame members and the outer edges of the trim boards for urging the terminal ends of the trim boards into abutting relation.

31. The trim tool set forth in claim 27 wherein said corner assembly includes a mounting support and a pair of right angularly disposed clamp means mounted on said mounting support for detachably clamping said trim members to said frame members; each of said clamp means including inner and outer opposing clamp faces for clamping against one of said inner planar faces and one of said outer edges, respectively, and means for moving said inner and outer clamp faces between nonclamping positions and clamping positions clamped to said one inner face and said one outer edge, respectively.

32. The trim tool set forth in claim 31 wherein said outer clamp face projects rearwardly toward the vertical face a predetermined distance relative to said mounting support and said inner clamp face projects rearwardly from said mounting support a greater predetermined distance.

33. The trim tool set forth in claim 27 wherein said corner assembly includes a mounting support adapted to be spaced forwardly from the vertical wall, and a pair of right angularly related clamp means mounted on said mounting support for clamping said trim members to said opening frame members; each of said clamp means including inner and outer clamp arms projecting rearwardly away from said mounting support; said outer clamp arm including a terminal end for bearing against the vertical face of the wall and said outer clamp face being disposed on a terminal portion of said outer clamp arm adjacent said terminal end.

34. The trim tool set forth in claim 33 wherein said inner clamp arm projects rearwardly from said mounting support a greater predetermined distance greater than said predetermined distance and includes a terminal portion mounting said inner clamp face.

35. The trim tool set forth in claim 34 wherein said clamp means includes means for moving said inner clamp face relative to said inner clamp arm.

36. The trim tool set forth in claim 35 wherein said means for moving said inner clamp face is rotatable about an axis.

37. The trim tool set forth in claim 36 including means mounting said inner and outer clamp arms together for relative movement to any selected one of a plurality of different spaced apart preset positions prior to being mounted on the opening frame members.

38. The trim tool set forth in claim 37 wherein said means mounting said inner and outer clamp arms comprises an aperture in said inner arm and a rod coupled to said outer arm and slidably received in said inner arm.

39. The trim tool set forth in claim 38 wherein said rod has a plurality of spaced apart teeth for engaging a portion of said inner arm adjacent said aperture for detachably holding said outer arm in any selected one of said plurality of present positions.

40. A trim tool for trimming an opening casing having a pair of opening frame members lying in a pair of planes intersecting each other at a 900 angle; said trim tool comprising:
a corner clamp assembly for detachably clamping right angularly disposed coplanar trim members, lying in a third plane perpendicular to each of said pair of planes, to the pair of opening frame members.

41. The trim tool set forth in claim 40 wherein said clamp assembly includes
a mounting support, and
a pair of right angularly disposed clamp members mounted on said mounting support, each clamp member including inner and outer relatively moveable clamp faces, and
means for relatively moving said inner and outer faces toward and away from each other between non-clamping positions and clamping positions in which said outer face is clamped to one of said trim members and said inner face is clamped to one of said frame members.

42. The trim tool set forth in claim 40 wherein said clamp assembly includes
a mounting support;
a pair of right angularly disposed clamp members mounted on said mounting support, each clamp member including inner and outer relatively moveable parallel clamp arms mounted on said mounting support;
said inner clamp arm being longer than said outer clamp arm; and
means for relatively moving said inner and outer clamp arms toward and away from each other between non-clamping positions and clamping positions in which said outer arm is clamped to one of said trim members and said inner arm is clamped to one of said frame members.

43. The trim tool set forth in claim 42 wherein said clamp assembly includes means mounting said outer clamp arm on said inner clamp arm for limited relative swinging movement as said inner and clamp arms are forced into clamping engagement with said inner face of said opening frame member and said outer edge of said trim frame member, respectively.
